(19) United States
(12) Patent Application Publication
(10) Pub. No.: US 2016/0367995 A1
(43) Pub. Date: Dec. 22, 2016

(54) Roller with Replaceable Edge Reinforcements

(71) Applicant: Cast Steel Products LP, By Its General Partner Cast Steel Products GP Ltd., Edmonton (CA)

(72) Inventors: Dustin Birtch, Edmonton (CA); John McIntyre, Edmonton (CA); Nick Meeboer, Edmonton (CA)

(73) Assignee: Cast Steel Products LP, By Its General Partner Cast Steel Products GP Ltd., Edmonton (CA)

(21) Appl. No.: 15/191,130

(22) Filed: Jun. 23, 2016

Related U.S. Application Data
(63) Continuation of application No. PCT/CA2015/050121, filed on Feb. 18, 2015.
(60) Provisional application No. 61/941,884, filed on Feb. 19, 2014.

(51) Int. Cl. B02C 4/30

(52) U.S. Cl. CPC B02C 4/305; B02C 2210/02

(57) ABSTRACT

A roller with replaceable edge reinforcements is provided. A plurality of removable edge reinforcements are disposed radially along the peripheral edge of the end face of the roller. The reinforcements are slidably connected to the end face of the roller, either directly or indirectly, using male and female interlocking members, preferably in a U-shaped dovetail. The edge reinforcements are constructed from a suitably hard material and accept wear in place of the peripheral edge of the roller itself. In some embodiments, a pin and dimple arrangement is provided to assist the sliding engagement of the male and female members. A tool recess may also be provided to assist with removing the edge reinforcements.

### RELATED APPLICATIONS

This application is a continuation of International App. No. PCT/CA2015/050121 entitled “ROLLER WITH REPLACEABLE EDGE REINFORCEMENTS” filed on Feb. 18, 2015; which claims priority on U.S. App. No 61/941,884 entitled “ROLLER WITH REPLACEABLE EDGE REINFORCEMENTS” filed on Feb. 19, 2014, both of which are incorporated by reference herein in their entirety.

### TECHNICAL FIELD

The present invention relates to rollers and grinders for industrial use, including mining, trash compaction and other uses. In particular, the present invention relates to surface reinforcements for rollers subjected to wear conditions and methods of replacing same.

### BACKGROUND

Friction-based rollers are common components of many machines. A frequent problem with such rollers is wear on the roller surface over time, particularly if the roller is subjected to large frictional forces. When the surface of the roller begins to wear out or becomes uneven, the roller must then be replaced or the surface of the roller must be remanufactured.

Frictional wear is particularly problematic for industrial rollers used to crush, compact, shred, or grind materials. Industrial rollers are used extensively in mining operations to crush rock, ore, and other brittle materials into smaller particles. Industrial rollers can also be used for trash compaction or in other applications where high throughput crushing, shredding, or compaction is required.

Two basic types of industrial rollers are commonly used for crushing, compacting, or shredding ; the first being a single roller operating adjacent to a stationary curved anvil plate and the second being a double counter-rotating set of rollers having parallel axes and a gap between the rollers. Particle output size from a roller or pair of rollers is determined by the size of the gap, also known as the ‘nip’, between the roller surface and the opposing surface, such as an anvil plate or opposing roller. Material is drawn into the nip by the rotating motion of the roller surface and exits the nip in a continuing stream of crushed, compacted, or shredded material.

In many industrial applications, particularly in the mining industry, industrial rollers are subjected to extremely high pressures and/or are used to crush relatively hard materials, both of which can result in significant frictional wear on the rollers. While wear can occur at various points along the surface of the roller, the peripheral edges of the roller are often susceptible to wear.

One conventional approach to extending the life of an industrial roller is to reinforce the roller surface with extremely hard materials, such as tungsten carbide. Nevertheless, even the hardest materials will wear out over time and so this approach can only extend the time required before the roller must be replaced or remanufactured in order to provide an even surface.

Although conventional carbide stud arrangements provide protection for the working surface of the roller, they often leave the end faces of the roller and the peripheral edges thereof exposed to wear. Wear along the peripheral edge of the roller can be particularly problematic for rollers used for ore crushing.

When an industrial roller reaches the end of its service life, it must be replaced or remanufactured. In many applications, particularly in the mining industry, industrial rollers can be quite large and so remanufacture is often preferred over complete replacement of the roller.

The remanufacture of a worn roller is not a simple or inexpensive task, involving removal of the entire roller from service, followed by extensive cutting, machining, and re-welding of the roller surface.

If the roller has no edge protection, the peripheral edges of a worn roller surface may exhibit a rounded profile. In order to eliminate these rounded edges, the peripheral edge of the roller must be either built up through welding processes or the surface of the roller must be machined down until the peripheral edge becomes square. In either case, the process is expensive and time consuming.

### SUMMARY OF THE INVENTION

The present invention is directed to a roller with replaceable edge reinforcements. A plurality of removable edge reinforcements are disposed radially along the peripheral edge of the end face of the roller. The reinforcements are slidably connected to the end face of the roller, either directly or indirectly, using male and female interlocking members, preferably in a U-shaped dovetail. The edge reinforcements are constructed from a suitably hard material and accept wear in place of the peripheral edge of the roller itself. In some embodiments, a pin and dimple arrangement is provided to assist the sliding engagement of the male and female members. A tool recess may also be provided to assist with removing the edge reinforcements.

In one broad aspect, there is provided a roller having a reinforced edge. The roller comprises a roller body rotating about a central axis, the roller body having a roller surface and a roller end face that meets the roller surface at a peripheral edge; and a plurality of detachable edge reinforcements slidably engaged to the roller end face via opposed interlocking male and female members, the edge reinforcements arranged radially along the peripheral edge to form a reinforced edge of the roller.

In some embodiments, the interlocking male and female members form a dovetail connection, preferably a U-shaped dovetail. In some cases, at least one female member is disposed on the roller end face and at least one male member is disposed on the edge reinforcement. Alternatively, or in addition, at least one male member is disposed on the roller end face and at least one female member is disposed on the edge reinforcement.

In some embodiments, the roller end face comprises one or more detachable annular plates disposed along the peripheral edge of the roller body for receiving the plurality of detachable edge reinforcements slidably engaged thereto.

In some embodiments, the roller end face comprises one or more surface segments disposed along the surface of the roller, adjacent the peripheral edge, for receiving the plurality of detachable edge reinforcements slidably engaged thereto.

In some embodiments, the male or female member further comprises a pin disposed on the male or female member and extending into the slidable engagement there between; and a dimple disposed on the opposing female or male member in alignment with and for receiving the pin.

In some embodiments, the roller further comprises a plurality of tool recesses disposed on the roller end face, each tool recess being in communication with at least one of the plurality of edge reinforcements for assisting the detachment of the edge reinforcement. In some examples, each of the plurality of edge reinforcements is in communication with at least one tool recess, the tool recesses are oriented in a radial pattern along the roller end face, and the plurality of tool recesses are closer to the central axis of the roller than the edge reinforcements.

In some embodiments at least one of the plurality of edge reinforcements comprises a shoulder that forms a portion of the roller surface.

In another broad aspect, there is provided a detachable edge reinforcement for a roller having a roller surface and a roller end face which meets the roller surface at a peripheral edge, the detachable edge reinforcement comprising a body for resisting wear at the peripheral edge; and an interlocking member for slidable engagement with an opposed interlocking member on the roller end face.

In some embodiments, the interlocking member on the edge reinforcement is a male member and the opposed interlocking member on the roller end face is a female member. In some cases, the interlocking member is dovetailed, preferably a U-shaped dovetail.

In some embodiments, the detachable edge reinforcement further comprises a dimple for receiving a pin disposed on the roller end face; or a pin for engaging a dimple disposed on the roller end face. In some examples, the edge reinforcement further comprises a shoulder that forms a portion of the roller surface.

In another broad aspect of the invention, there is provided an annular plate for a roller having a roller surface and a roller body which meets the roller surface at a peripheral edge, the annular plate detachabiy coupled to the peripheral edge, the annular plate comprising a dovetailed male or female member for slidable engagement with a detachable edge reinforcement as described above.

In some embodiments, the annular plate further comprises a tool recess for assisting the detachment of the slidable edge reinforcement, the tool recess disposed on the roller end face in communication with the edge reinforcement and extending away from the roller surface.

In another broad aspect of the invention, there is provided a surface segment for a roller having a roller surface and a roller end face which meets the roller surface at a peripheral edge, the surface segment comprising a dovetailed male or female member at the peripheral edge for slidable connection with a detachable edge reinforcement as described above.

In some embodiments, the surface segment further comprises a tool recess disposed on the surface segment in communication with the edge reinforcement and extending away from the roller surface for assisting the detachment of the edge reinforcement.

Directional terms such as “front” and “rear”, “top” and “bottom”, “first” and “second”, “right” and “left” are used herein purely for convenience of description. Such terms are used for illustration purposes and are not intended to limit the present disclosure. As well, and dimensions herein are not intended to limit the scope of the invention unless specifically stated. Furthermore, geometric terms such as “straight”, “flat”, “point” and the like are not intended to limit the invention to the level of geometric precision, but should instead be understood in the context of the invention which includes such departures from geometric position as the manufacturing tolerances that are normal and/or acceptable in the field of this invention, as well as the functional requirements of products in the field of the invention wherein a high level of precision may not be required.

### BRIEF DESCRIPTION OF THE DRAWINGS

The invention will now be described with reference to the attached drawings, which illustrate, by way of example only, embodiments of the invention contemplated herein :

FIG. 1 is a perspective view of a reinforced roller according to a first embodiment of the present invention.

FIGS 2A-2E are perspective (FIG. 2A), front (FIG. 2B), end (FIG. 2C), side (FIG. 2D), and top (FIG. 2E) views of an edge reinforcement according to an embodiment of the present invention.

FIG. 3 is a perspective view of a reinforced roller according to another embodiment of the present invention.

FIG. 4 is an enlarged perspective view, partly broken away, of the reinforced roller of FIG. 3.

FIG. 5 is a perspective view of the reinforced roller of FIG. 3, in a partially disassembled state.

FIG. 6 is a front view of an annular plate according to one embodiment of the present invention.

FIG. 7 is a perspective view of a reinforced roller according to a further embodiment of the present invention, in a partially disassembled state.

FIGS 8A-8B are a perspective view (FIG. 8A) and plan view (FIG 8B) of a surface segment of the roller of FIG. 7.

FIG. 9 is a perspective view of a reinforced roller according to yet another embodiment of the present invention, in a partially disassembled state.

FIGS 10A-10B are a side view (FIG. 10A) and enlarged top view (FIG. 10B) of a female member of the roller of FIG. 9.

FIGS 11A-11D are perspective (FIG. 11A), front (FIG. 11B), end (FIG. 11C), and side (FIG. 11D) views of an edge reinforcement of the roller of FIG. 9.

### DETAILED DESCRIPTION

Referring now to the drawings, various embodiments of the invention will now be disclosed.

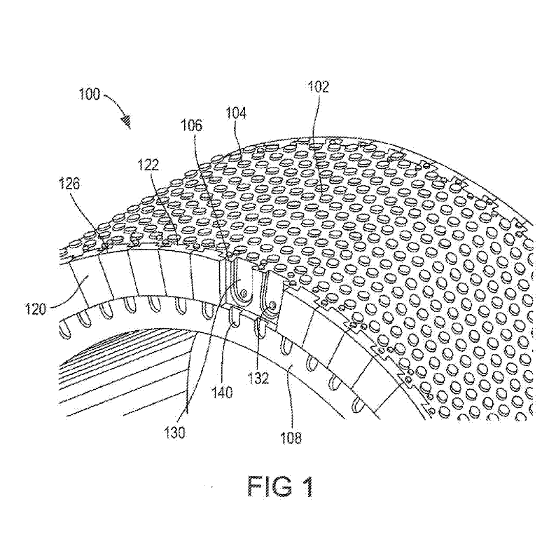

FIG. 1 depicts an edge-reinforced roller 100 according to a first embodiment of the present invention. Generally speaking, a plurality of edge reinforcements 120 surround the peripheral edge 106 of the end face 108 of the roller 100. The edge reinforcements 120 slidably engage the end face 108 of the roller 100 via male and female members 122, 130.

In this embodiment, the male member 122 is disposed on the edge reinforcements 120 and slidably engages with a female member 130 disposed on the end face 108 of the roller 100. In other embodiments, the relationship of the male and female members 122, 130 may be reversed, such that the edge reinforcements 120 bear female members 130 and the end face 108 of the roller 100 bears male members 122.

In the embodiment shown in FIG. 1, the sliding engagement between the male and female members 122, 130 is an interlocking relationship, in this case a dovetail. More specifically, a U-shaped dovetail is provided in which the angle subtended between the side and face of the member is preferably between 70 and 75 degrees. This interlocking arrangement secures the edge reinforcement 120 against movement along the axis of the roller 100. Other forms of interlocking relationships between the male and female members 122, 130 are also contemplated, such as members having interlocking concave/convex shapes or various profiles having a narrow stem and a wider head.

The edge reinforcements 120 provide wear surfaces along the peripheral edge 106 of the roller 100 and can be individually replaced when lost, worn, or broken. The edge reinforcements 120 are preferably constructed of a hardened material, such as tungsten carbide. When assembled, the wear surfaces of the plurality of edge reinforcements 120 provide a reinforced edge 126 to resist wear along the peripheral edge 106 the roller 100.

In this embodiment, the invention further comprises a series of tool recesses 140, which are aligned with the edge reinforcements 120. When an edge reinforcement 120 is damaged or broken, the tool recesses 140 permit the insertion of a finger or a tool in the tool recess 140 to thereby access the bottom of the edge reinforcement 120, on the side closer to the axis of rotation. Pulling, pushing, or hammering actions may then be used to loosen and withdraw the edge reinforcement 120 from its slidable engagement to the female member 130 disposed on the end face 108 of the roller 100. The presence of tool recesses 140 is optional, and where present, preferably includes one tool recess 140 for each edge reinforcement 120.

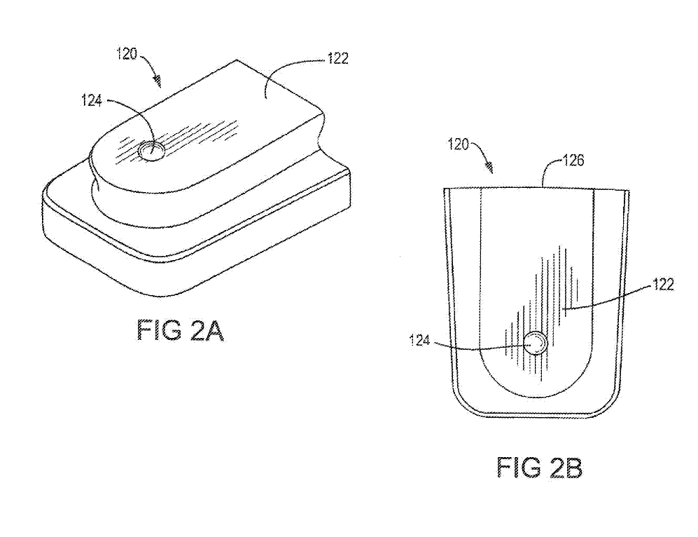

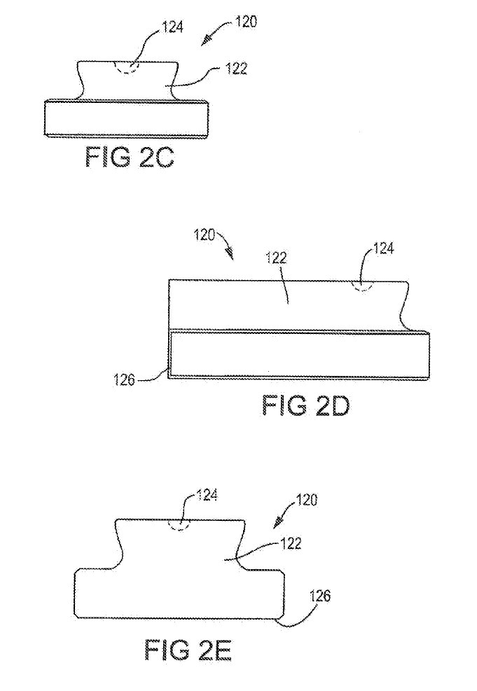

The sliding engagement between the male and female members 122, 130 may be further enhanced in some embodiments through the use of a pin 132 in alignment with a dimple 124 on the opposing member. In the embodiment shown in FIG. 1, the pin 132 is provided on the female member and aligns with a dimple 124 on the male member of the edge reinforcement 120 (See FIG. 2A). The pin 132 extends into the slidable engagement between the male and female members 122, 130, in a direction substantially parallel to the axis of rotation. In other embodiments, the arrangement of the pin 132 and dimple 124 may also be reversed as between the male and female parts. For example, in some embodiments, the pin 132 may be disposed on the male member 122 and the dimple may be disposed on the female member 130.

Insertion of the edge reinforcement 120 into the female member 130 aligns the pin 132 with the dimple 124. In some embodiments, this results in an audible ‘click’ that informs the technician that the edge reinforcement 120 has been fully and correctly inserted in the roller 100. Frictional engagement of the pin 132 against the dimple 124 may also assist in holding the edge reinforcement 120 in place against centrifugal forces generated during operation. In such cases, the use of a pin 132 may also aid other fasteners, such as glues, in holding the edge reinforcement 120 in place.

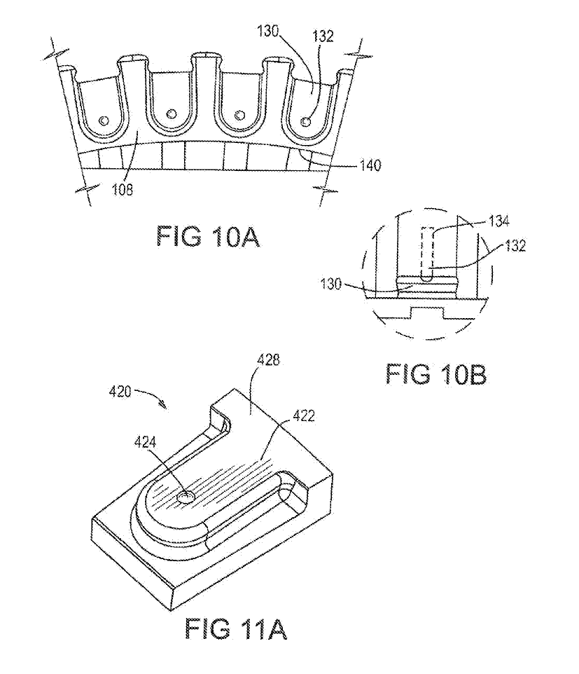

The insertion process can be made easier in some embodiments by constructing the pin 132 from a resilient material, such as a polymer plastic. As can be best seen in FIG. 10B, a pin 132 constructed of a resilient material, such as plastic, can be set in a recess 134 which provides lateral support so as to resist shearing during use. Non-resilient pins may also benefit from such construction, particularly when they are not a unitary component of the male or female member, nevertheless a recessed arrangement is preferable where the pin 132 is of resilient construction.

FIGS 2A-2E provide a number of views of an edge reinforcement 120 according to the present invention. A reinforced edge 126 is located at the periphery of the roller 100 when assembled. In this embodiment, a dimple 124 is provided on the male member 122. As discussed above, in other embodiments the pin 132 may be provided on the male member 122. In still further embodiments, the pin 132 or dimple 124 may be absent.

A number of alternative embodiments also exist, in which the end face 108 includes one or more additional parts that mediate the sliding engagement with the edge protectors 120.

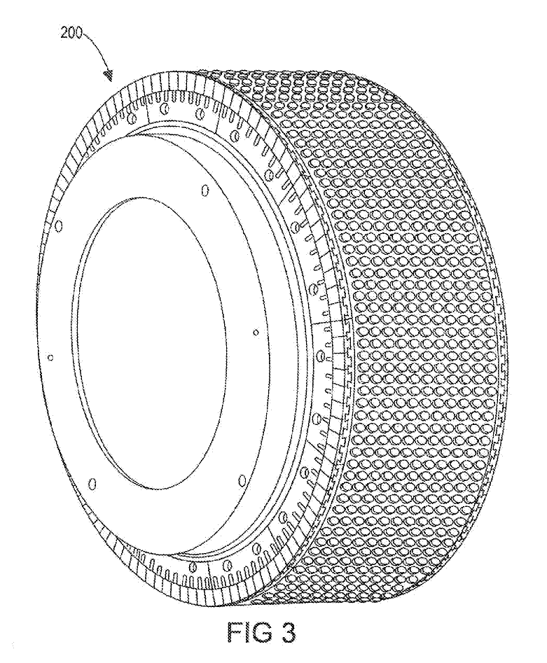

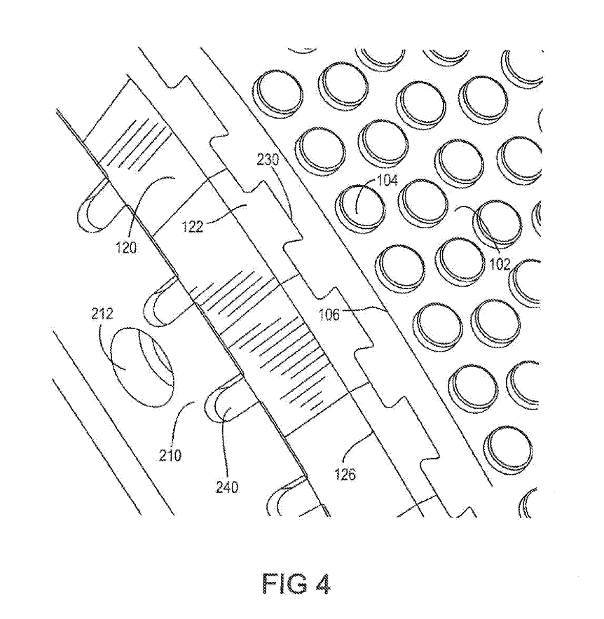

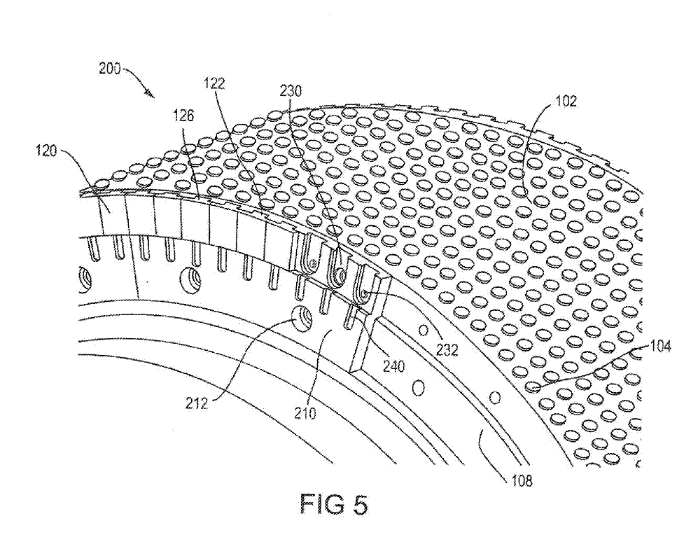

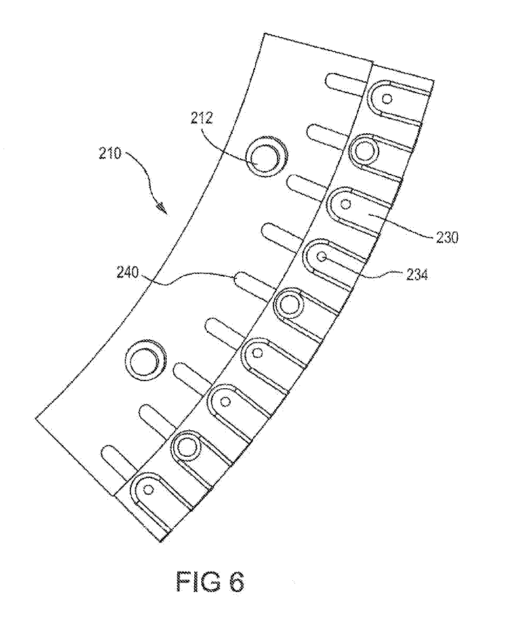

For example, FIGS 3-5 depict an alternative embodiment in which the edge reinforcements 120 are received by detachable annular side plates 210, which are bolted to the roller at bolt holes 212. The inclusion of a detachable annular plate 210 on the end face 108 of the roller 200 allows for easier repair of male or female members on the end face 108 of the roller if they become damaged during operation of the roller 200. In this embodiment, the annular plate 210 also includes tool recesses 240 and pins 232, which serve the same functions described above for tool recess 140 and pin 132. FIG. 6 provides an enlarged view of an annular plate 210, including pin recesses 234 disposed therein to strengthen the pins 232. As with the embodiment described above, the male and female engagement between the end face 108 of the roller 200, in this case via the annular plate 210, can be reversed such that a male member (not shown) is provided on the annular plate 210. Similarly, the pin and dimple arrangement is optional and where present, may be reversed in some embodiments, such that the annular plate 210 carries the dimple (not shown) rather than a pin 232.

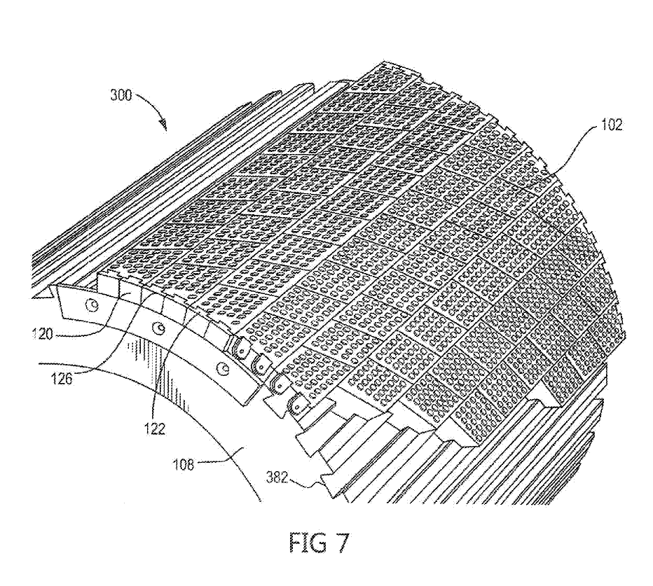

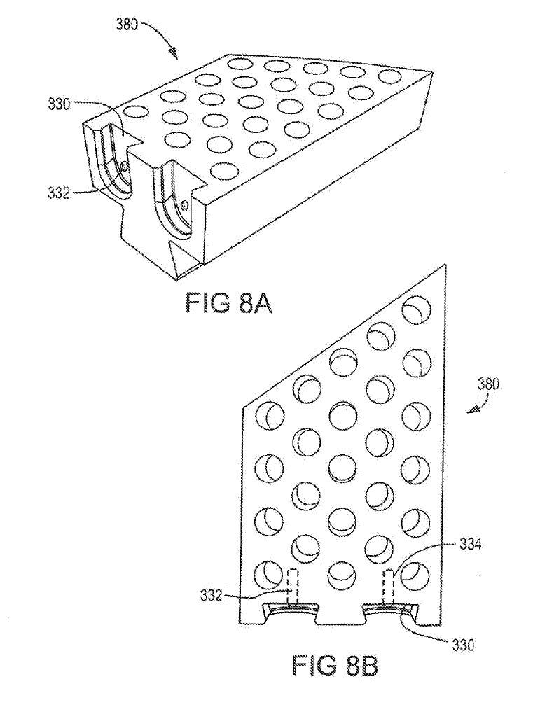

FIGS 7-8B depict another variation in which the surface 102 of the roller 300 is comprised of a number of surface segments 380. Such surface segments 380 are the subject of U.S. provisional application by CSP Innovative Engineering Ltd. entitled “Roller With Replaceable Surface Segments and Method of Reconditioning Same”, filed Feb. 19, 2014, which is incorporated herein by reference. In this embodiment, the surface segments 380 are attached to a central hub 382, in this case by a sliding dovetail engagement.

In this embodiment, surface segments 380 situated along the periphery 106 of the roller 300 form a portion of the end face 108 of the roller 300 and carry the female members 330 to which the male member 122 of the edge reinforcement 120 slidably engage. In other embodiments, tool recesses are provided on the surface segment, which serve an analogous function to tool recesses 140 and 240 discussed above.

As seen in FIG. 8B, the surface segments 380 in this embodiment may also include a pin 332 set in a pin recess 334, which operates in the manner described above. As with the other embodiments, the male and female engagement between the end face 108 of the roller 300, in this case via the surface segment 380, can be reversed such that a male member (not shown) is provided on the surface segment 380. Similarly, the pin and dimple arrangement is optional and where present, may be reversed in some embodiments, such that the surface segment 380 carries the dimple (not shown) rather than a pin 332.

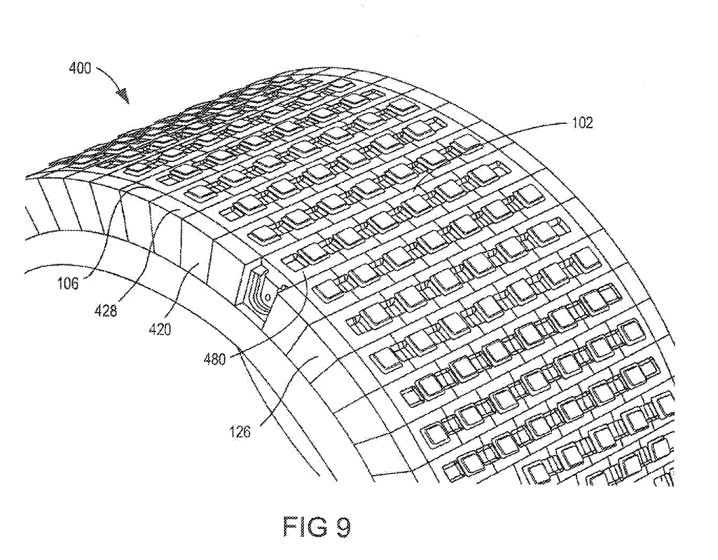

FIGS 9-10B depict yet another variation in which the surface 102 of the roller 400 is comprised of surface segments 480. In this embodiment, the surface segments 480 do not form part of the end face 108 of the roller 400. Instead, the edge reinforcements 420 engage the end face 108 of the roller 400 in a manner similar to the embodiment shown in FIG. 1. However, unlike the edge reinforcements 120 in FIG. 1, the edge reinforcements 420 in FIG. 9 further include a shoulder 428 which forms part of the surface 102 of the roller 400. In some applications, the use of a shoulder 428 which forms part of the surface 102 of the roller 400 may aid the retention of the edge reinforcement 420 during operation.

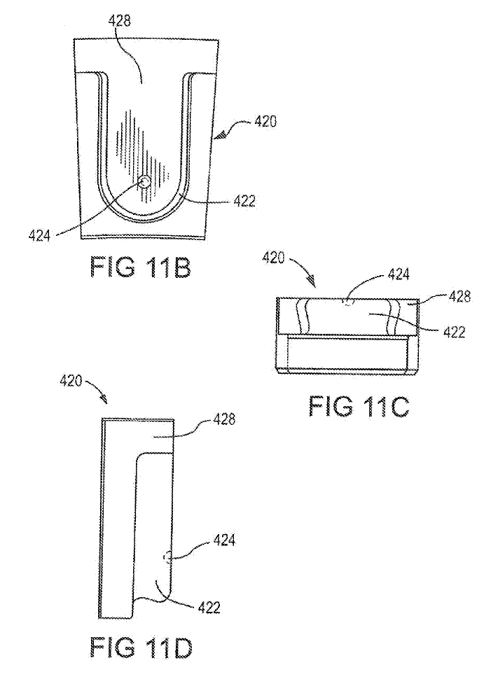

FIGS 11A-11D provide enlarged views of the edge reinforcement 420 shown in FIG. 9. As discussed above, a shoulder 428 is provided which forms part of the surface 102 of the roller 400. In this embodiment, the shoulder 428 is continuous with the roller surface 102. In other embodiments the shoulder 428 may extend beyond the roller surface 102 to create a surface feature along the peripheral edge 106 of the roller 400. Thus, the shoulder 428 may also in some cases allow the edge reinforcement 420 to extend beyond the maximum height of the male or female member on the roller end face 108. The provision of a shoulder 428 may also prevent block entry of foreign material between the sliding engagement of the male and female members, which secure the edge reinforcement 420 to the end face 108 of the roller 400.

As with the previous examples, a male member 422 is provided along with a dimple 424, both of which operate as discussed in respect of the male member 122 and dimple 124 above. As with the other embodiments, the male and female engagement between the end face 108 of the roller 400 can be reversed such that a female member (not shown) is provided on the edge reinforcement 420. Likewise, the pin and dimple arrangement is optional and where present, may be reversed in some embodiments, such that the edge reinforcement 420 carries the pin (not shown) rather than a dimple 424.

In operation, a roller 100, 200, 300, 400 according to the present invention will have a reinforced edge 126. The resulting reinforcement may extend the service life of such rollers, by resisting rounding of the peripheral edge 106 due to frictional wear.

Edge reinforcements 120, 420 that are broken, worn, or lost can be replaced by sliding in replacement pieces. In embodiments which include a tool recess 140, 240, this process may be assisted by placing a tool on the underside of the edge reinforcement 120, 420 and striking it with a hammer.

In embodiments which include a pin and dimple, the complete insertion of a replacement edge reinforcement 120, 420 may be indicated by a positive connection, preferably a click. This may help to ensure that each reinforcement is fully inserted before the unit is returned to operation, which in turn may reduce the loss of edge reinforcements and may increase safety during operation of the roller 100, 200, 300, 400.

In embodiments in which the end face 108 of the roller 200 includes a removable annular plate 210 to which the edge reinforcements are attached, damaged male or female members on the end face 108 of the roller 200 may be replaced by replacing the annular plate 210. Such damage may occur when an edge reinforcement 120, 420 has been lost, particularly since the annular plates 210 may not be constructed from the same hardened material as the edge reinforcements 120, 420.

Similar considerations apply where the end face 108 of the roller 300 is comprised of surface segments 380, in that damage to the male or female members on the end face 108 of the roller 300 can be corrected by replacing the surface segments 380, rather than machining the roller 300 itself.

The embodiments of the present disclosure are intended to be examples only. Those of skill in the art may effect alterations, modifications and variations to the particular embodiments without departing from the intended scope of the present application.

In particular, features from one or more of the above-described embodiments may be selected to create alternate embodiments comprised of a subcombination of features which may not be explicitly described above. In addition, features from one or more of the above-described embodiments may be selected and combined to create alternate embodiments comprised of a combination of features which may not be explicitly described above. Features suitable for such combinations and subcombinations would be readily apparent to persons skilled in the art upon review of the present application as a whole. The subject matter described herein and in the recited claims intends to cover and embrace all suitable changes in technology.

1-22. (canceled)

23. A roller having a reinforced edge, the roller comprising:
a roller body configured to rotate about a central axis, the roller body having a roller surface and a roller end face that meets the roller surface at a peripheral edge; and
a plurality of detachable edge reinforcements slidably engaged to the roller end face via opposed interlocking male and female members, the edge reinforcements arranged radially along the peripheral edge to form a reinforced edge of the roller.

24. The roller of claim 23, wherein the interlocking male and female members form a dovetail connection.

25. The roller of claim 24, wherein the dovetail is U-shaped.

26. The roller of claim 23, wherein at least one female member is disposed on the roller end face and at least one male member is disposed on the edge reinforcement or at least one male member is disposed on the roller end face and at least one female member is disposed on the edge reinforcement.

27. The roller of claim 23, wherein the roller end face comprises one or more detachable annular plates disposed along the peripheral edge of the roller body for receiving the plurality of detachable edge reinforcements slidably engaged thereto.

28. The roller of claim 27, wherein the interlocking male and female members permit reciprocal movement of the edge reinforcements in the radial direction when the detachable annular plates are secured to the peripheral edge of the roller body.

29. The roller of claim 23, wherein the roller end face comprises one or more surface segments disposed along the surface of the roller, adjacent the peripheral edge, for receiving the plurality of detachable edge reinforcements slidably engaged thereto.

30. The roller of claim 23, wherein at least one male or female member comprises:
a pin disposed on the male or female member and extending into the slidable engagement there between; and
a dimple disposed on the opposing female or male member in alignment with and for receiving the pin.

31. The roller of claim 30 wherein the pin is constructed from a resilient material.

32. The roller of claim 23, wherein at least. one of the plurality of edge reinforcements comprises a shoulder that forms a portion of the roller surface.

33. A detachable edge reinforcement for a roller having a roller surface and a roller end face which meets the roller surface at a peripheral edge, the detachable edge reinforcement comprising:
a body for resisting wear at the peripheral edge; and
an interlocking member for slidable engagement with an opposed interlocking member on the roller end face.

34. The detachable edge reinforcement of claim 33, wherein the interlocking member is dovetailed.

35. The detachable edge reinforcement of claim 34, wherein the dovetail is U-shaped.

36. The detachable edge reinforcement of claim 33, wherein the interlocking member on the edge reinforcement is a male member and the opposed interlocking member on the roller end face is a female member.

37. The detachable edge reinforcement of claim 33, further comprising:
a dimple for receiving a pin disposed on the roller end face; or
a pin for engaging a dimple disposed on the roller end face.

38. The detachable edge reinforcement of claim 33, further comprising a shoulder that forms a portion of the roller surface.

39. An annular plate for a roller having a roller surface and a roller body which meets the roller surface at a peripheral edge, the annular plate detachably coupled to the peripheral edge, the annular plate comprising:
a dovetailed male or female member for slidable engagement with a detachable edge reinforcement according to claim 33.

40. A roller, the roller comprising:
a roller body configured to rotate about a central axis, the roller body having a roller surface for contacting a material and opposed end faces;
an end plate secured to each one of the opposed end faces, the end plate comprising an exterior facing surface, and an end facing surface;
a plurality of edge protectors extending radially outwards about the central axis, the protectors having a working surface for contacting the material;
a retaining means for securing the edge protectors to the exterior facing surface of the end plate, wherein the retaining means permits reciprocal sliding movement of the edge protectors in the radial direction when the end plate is secured to each one of the opposed end faces.

41. The roller of claim 40, wherein the retaining means comprises male and female interlocking members.

42. The roller of claim 41, wherein the end plate comprises the female interlocking member and the edge protectors comprise the male interlocking member.
